(19) United States
(12) Patent Application Publication
(10) Pub. No.: US 2008/0232761 A1
(43) Pub. Date: Sep. 25, 2008

(54) METHODS OF MAKING OPTICAL WAVEGUIDE STRUCTURES BY WAY OF MOLECULAR BEAM EPITAXY

(76) Inventors: Raveen Kumaran, Vancouver (CA); Shawn Penson, Vancouver (CA); Ivan-Christophe Robin, Vancouver (CA); Thomas Tiedje, Vancouver (CA)

Correspondence Address: THOMAS LOOP, P.O. BOX 21466, SEATTLE, WA, 98111, US

(21) Appl. No.: 11/858,857

(22) Filed: Sep. 20, 2007

Related U.S. Application Data
(60) Provisional application No. 60/826,374, filed on Sep. 20, 2006.

(51) Int. Cl. G02B 6/00; C03B 15/14

(52) U.S. Cl. 385/142; 117/3

(57) ABSTRACT

The invention relates to methods of making optical waveguide structures by way of molecular beam epitaxy (MBE). The method comprises the steps of: (1) providing a single crystal substrate in an ultra-high vacuum (UHV) environment, wherein the single crystal substrate has a first index of refraction; (2) heating the single crystal substrate; (3) depositing an epitaxial oxide layer having a rare-earth dopant and a second index of refraction on the single crystal substrate, wherein the epitaxial oxide layer is deposited by way of at least first, second, and third molecular beam fluxes; and (4) depositing a cladding layer on the single crystal oxide layer, wherein the cladding layer has a third index of refraction that is the same or about the same as the first index of refraction of the single crystal substrate, and wherein the second index of refraction is greater than the first and third indexes of refraction.

### CROSS-REFERENCE TO RELATED APPLICATION

This application claims the benefit of priority of U.S. Provisional Application No. 60/826,374 filed on Sep. 20, 2006, which application is incorporated herein by reference in its entirety for all purposes.

### FIELD OF THE INVENTION

The present invention relates to optical waveguide structures and, more specifically, to methods of making optical waveguide structures that are that are suitable for use in diode pumped solid state waveguide lasers, as well as to optical waveguide structures made by the methods disclosed herein.

### BACKGROUND OF THE INVENTION

An optical waveguide is a physical structure that guides electromagnetic waves in the optical spectrum. Common types of optical waveguides include optical fiber and rectangular waveguides. Optical waveguides can be classified according to their geometry (planar, strip, or fiber waveguides), mode structure (single-mode, multi-mode), refractive index distribution (step or gradient index) and material (glass, polymer, semiconductor). Optical waveguides have been used in association with diode-pumped solid-state (DPSS) lasers.

Importantly, there is a continuing need for better performance laser sources and a variety of improvements have been suggested for DPSS lasers such as thin-disk media (H. Huegel, W. L. Bohn, “Solid state thin-disk laser,” Proc. SPIE Int. Soc. Opt. Eng. 3574, 15 (1998)), different pumping schemes (W. Koechner, “Solid-State Laser Engineering,” 4^{th} ed., Springer-Verlag, N.Y., 1996), and new materials (A. A. Kaminskii, “Modern developments in the physics of crystalline laser materials,” Phys. Stat. Sol. (a) 200, 251 (2003)). In the past few years, one of the more promising methods that has been suggested for making better DPSS systems is the adoption of waveguide technology analogous to semiconductor lasers and fibre lasers (J. Song, A. Liu, K. Okino, K. Ueda, “Virtual point source pumped CW Nd:YAG laser with 81 W output from linear cavity and 22 W output from ring cavity,” Jpn. J. Appl. Phys., 35, L1268 (1996)). A double-clad structure in which the active layer has a higher refractive index than the substrate and the top cladding layer, allows the active medium to guide the laser emission as well as the divergent pump radiation.

Good results have been achieved with YAG/sapphire waveguides. For example, 4.3 W of output at 1064 nm has been obtained with a 7-W diode pump (J. I. Mackenzie, Cheng Li, and D. P. Shepherd, “Multi-Watt, High Efficiency, Diffraction-Limited Nd:YAG Planar Waveguide Laser,” IEEE J. Quant. Electr., 39, No. 3, 493 (2003)). In order to take full advantage of the waveguide geometry in solid-state lasers one needs a reliable, efficient, and scalable technology for fabrication of these waveguides. A number of different techniques can potentially be used in the production of single crystal waveguide lasers.

For example, ion implantation with high energy (up to several MeV) helium (He⁺) or hydrogen (H⁺) ions can be used to form waveguides (S. J. Field, D. C. Hanna, D. P. Shepherd, A. C. Tropper, P. J. Chandler, P. D. Townsend, Lin Zhang, “Ion implanted Nd:YAG waveguide lasers,” IEEE J. Quant. Electr., 27, No. 3, 428 (1991)). The optical waveguide layer is formed between crystal-air interface and the low-index optical barrier, created by ions at a depth of several microns. This method can only create a waveguide layer on the top of a bulk crystal. As a result, it is impossible to create multi-layers with different concentrations of active ions.

Sputtering is another potential method for making multilayer waveguide structures (Y. B. Choi, S. H. Cho, D. C. Moon, “Er Al-codoped silicate planar light waveguide type amplifier fabricated by radio-frequency sputtering,” Optics Letters, 25, No. 4, 263 (2000)). However, with this technique, it is difficult to produce epitaxial single crystal films with complex stoichiometries.

In Liquid Phase Epitaxy (LPE), growth proceeds by precipitation of material from a melt onto a single crystal substrate. In C. L. Bonner, C. T. A. Brown, D. P. Shepherd, W. A. Clarkson, A. C. Tropper, D. C. Hanna, B. Ferrand, “A diode-bar end-pumped, high power, Nd:Y₃AI₅O₁₂ planar waveguide laser,” Optics Letters, 23 (12), 942 (1998), laser experiments with LPE grown structures are reported. The 5 mm long waveguide had an 80-μm thick 1.5 at % Nd:YAG core sandwiched between a substrate and protective cladding layer of undoped YAG. The output power of this waveguide laser was 6 W for a diode-bar pumping power of 20 W. With LPE it is difficult to produce thin structures with well-controlled homogeneous compositions, due to melt-back effects during the growth process. This is a fundamental limitation of the LPE technique. Another problem with LPE is the unavoidable impurities which arise from the melt and growth environment.

The Pulsed Laser Deposition (PLD) technique involves ablation of a solid target in an ultra-high-vacuum chamber by means of short and high-energy laser pulses and condensation of the vapour on a substrate. Because of extremely high heating rate (10⁸ K/s) the target evaporates congruently irrespective of the evaporation point of the constituent elements or compounds of the target. One of the major problems of PLD is the deposition of particulates on the film. The size of particulates may be as large as a few microns. These features limit the use of PLD in production of large-area uniform thin films. PLD has not been fully deployed in industry as a result. In addition, there are indications that films grown by this method have inferior properties compared to those of bulk crystals. Most likely, it is the small defects in the crystal structure and the stoichiometry, inevitable in PLD growth, that cause detrimental broadening of fluorescence spectra and significantly lower the absorption coefficients (T. C. May-Smith, C. Grivas, D. P. Shepherd, R. W. Eason, M. J. F. Healy, “Thick film growth of high optical quality low loss (0.1 dB cm⁻¹) Nd:Gd₃Ga₅O₁₂ on Y₃Al₅O₁₂ by pulsed laser deposition,” Applied Surface Science 223, 361 (2004)).

The direct bonding method allows precision-polished materials to be joined together by van der Waals forces, with bond strengths sufficient to withstand further polishing down to a layer thickness of a few microns. This allows the production of multi-layer waveguides with bulk optical properties and low propagation losses. There are reports of laser devices made of planar double-clad YAG waveguides (C. L. Bonner, T. Bhutta, D. P. Shepherd, A. C. Tropper, “Double-Clad Structures and Proximity Coupling for Diode-Bar-Pumped Planar Waveguide Lasers,” IEEE J. Quant. Electr., 36, No. 2, 236 (2000)) that exhibit very good parameters. For example, 15-W output was obtained from a diode-pumped double-clad Tm:YAG waveguide laser (J. I. Mackenzie, S. C. Mitchell, R. J. Beach, H. E. Meissner, D. P. Shepherd, “A 15 W diode-side-pumped Tm:YAG waveguide laser at 2 μm,” Electronic Letters, 37, 898 (2001)) and powers of 2.7 to 4.3 W on different wavelengths have been obtained at 7-W pump power from a Nd:YAG double-clad planar waveguide laser (J. I. Mackenzie, Cheng Li, and D. P. Shepherd, “Multi-Watt, High Efficiency, Diffraction-Limited Nd:YAG Planar Waveguide Laser,” IEEE J. Quant. Electr., 39, No. 3, 493 (2003)).

Molecular Beam Epitaxy (MBE) can be used to grow high-quality single crystal oxide films. In the MBE process, directed thermal beams of atoms or molecules from heated effusion cells react on the clean surface of a substrate held at high temperature under ultra-high vacuum conditions to form an epitaxial film. The effusion cell temperatures control the beam fluxes, and mechanical cell shutters permit rapid switching of beam species and thus abrupt changes in layer composition and doping. A stainless-steel growth chamber is equipped with an ion pump, cryo-pump and sublimation pump yielding base pressures below 10⁻⁹ mBar. In addition, liquid-nitrogen-filled cryo-shrouds surround the effusion cells and the substrate. Thus, the substrate sees only cold walls onto which most impurities and re-evaporated layer constituents condense.

The stoichiometry of the deposited material is controlled by independent regulation of the intensity of the molecular beams. Growth rates are typically about 1 mono-layer per second. As a result, the thickness of the grown layer can be controlled with high precision. Moreover, it is possible to profile the dopant concentration in the growth direction. Complex integrated optical devices can be printed with masks (John R. Arthur, “Molecular beam epitaxy,” Surface Science 500, 189 (2002)).

MBE growth is typically carried out at about half the melting temperature, whereas bulk crystal growth from a melt is necessarily carried out at the melting point. The low growth temperature of MBE makes it possible to grow crystals with lower equilibrium defect densities such as anti-sites and vacancies and freeze in metastable phases or phases that are unstable at high temperature. For example, in the case of III-V semiconductors, MBE-grown GaAs films have much superior electronic properties than the best bulk GaAs crystals. Also metastable dilute III-V nitride alloys such as GaNAs can be grown in thin film form but cannot be grown from a melt. Of particular interest is the possibility of increasing the doping concentration in the active layers as compared to bulk crystals where this would be limited by dopant clustering.

Accordingly, and although significant progress has bee made in terms of new materials and methods associated with waveguide technology, there still exists a need in the art for novel methods of making optical waveguide structures. The present invention fulfills these needs and provides for further related advantages.

### SUMMARY OF THE INVENTION

In brief, the present invention is directed to a method for making an optical waveguide structure by way of molecular beam epitaxy (MBE). The inventive method comprises at least the following steps: (1) providing a single crystal substrate in an ultra-high vacuum (UHV) environment, wherein the single crystal substrate has a first index of refraction; (2) heating the single crystal substrate to a temperature of at least 600° C.; (3) depositing an epitaxial oxide layer of uniform thickness and having a second index of refraction on the single crystal substrate, wherein the epitaxial oxide layer includes at least one optically active rare-earth dopant, and wherein the epitaxial oxide layer is deposited by way of at least first, second, and third molecular beam fluxes, wherein the first molecular beam flux is a metallic molecular beam flux, the second molecular beam flux is a rare-earth element molecular beam flux, and the third molecular beam flux is a gaseous or plasma molecular beam flux; and (4) depositing a cladding layer on the epitaxial oxide layer, wherein the cladding layer has a third index of refraction that is the same or about the same as the first index of refraction of the single crystal substrate, and wherein the second index of refraction is greater than the first and third indexes of refraction. The inventive method may also include an initial step of annealing the single crystal substrate to a temperature of at least 900° C. and for a period of time sufficient to form a plurality of atomically flat terraces on the single crystal substrate.

The present invention is also directed to optical waveguide structures made by the inventive methods disclosed herein.

These and other aspects of the present invention will become more evident upon reference to the following detailed description and attached drawings. It is to be understood, however, that various changes, alterations, and substitutions may be made to the specific embodiments disclosed herein without departing from their essential spirit and scope.

### BRIEF DESCRIPTION OF THE DRAWINGS

The drawings are intended to be illustrative and symbolic representations of certain preferred and exemplary embodiments of the present invention and as such, they are not necessarily drawn to scale. Reference numerals and symbols are used to designate specific features that are schematically shown and described.

FIG. 1 depicts a process flow diagram associated with a method for making an optical waveguide structure in accordance with one embodiment of the present invention.

FIGS. 2a and 2b: XRD patterns of Y₂O₃ films grown a) on a Si (001) substrate at 800° C. and b) on sapphire (0001) substrate at 1100° C. The insets show omega scans of the (440) peak for the sample grown on silicon and the (222) peak of the sample grown on sapphire.

FIGS. 3a and 3b: Texture maps around off-axis peaks of the Y₂O₃ and of the substrate for sample grown a) on Si (100) and b) on sapphire (0001).

FIG. 4: PL of a 1.35% Nd:Y₂O₃ sample grown on sapphire (0001).

FIG. 5: PL intensity of the ⁴F_{3/2}→⁴I_{11/2} transitions for varying concentrations of Nd:Y₂O₃ grown on sapphire (0001).

### DETAILED DESCRIPTION OF THE INVENTION

The present invention is directed to novel methods of making optical waveguide structures that are suitable for use in diode pumped solid state waveguide lasers. In several of the embodiments disclosed herein, the inventive methods involve the use of molecular beam epitaxy (MBE). As is appreciated by those skilled in the art, MBE is a process for growing thin, epitaxial films of a wide variety of materials ranging from oxides to semiconductors to metals. In this highly sophisticated process beams of atoms or molecules in an ultra-high vacuum (UHV) environment are incident upon a heated crystal that has previously been processed to produce a nearly atomically clean surface. UHV means a growth chamber that can be pumped down to a pressure below 10⁻⁹ mBar at room temperature on a routine basis. The arriving constituent atoms form a crystalline layer in registry with the film (i.e., an epitaxial film). These films are remarkable because the composition can be rapidly changed so as to produce crystalline interfaces that are almost atomically abrupt. Although the particle beams that are used to deposit the layers can be either in the form of atoms or molecules, we make no distinction between molecular or atomic beams. In the case of atoms or molecules that have low vapour pressures at room temperature, the presence of the molecular beam flux has little effect on the chamber pressure. In the case of molecular beams that are normally gases at room temperature such as oxygen the presence of the molecular beam flux will increase the chamber pressure in proportion to the flux. In that the molecular beam is normally a gas at room temperature, its flux can be controlled by a leak valve or mass flow controller. In the case of a non-volatile element such as yttrium the molecular beam flux may be controlled by the temperature of an effusion cell source or the input power in the case of an electron beam gun. The maximum operating pressure of a molecular beam epitaxy reactor is in the range of 10⁻⁵ mBar.

In general, the optical waveguide structures disclosed herein are planar and include at least three distinct layers; namely, a higher refractive index core layer sandwiched between a lower refractive index substrate and a lower refractive index cladding layer. In certain preferred embodiments, the core layer is composed of neodymium (Nd) doped yttrium oxide (Y₂O₃) (i.e., Nd:Y₂O₃ with an atomic Nd concentration ranging from 1 to 3 percent) while the substrate is composed of sapphire and the cladding layer is composed of aluminum oxide (Al₂O₃). The core and cladding layers are deposited using MBE up to a preferred thickness of about 5 microns. The core layer is doped with an optically active rare-earth element such as, for example, cerium (Ce), neodymium (Nd), gadolinium (Gd), erbium (Er), praseodymium (Pr), holmium (Ho), or ytterbium (Yb). The rare-earth dopant concentration may be either uniform or non-uniform across the core layer. The substrate, core, and cladding layers are formed such that they are optically transparent at the desired lasing wavelength.

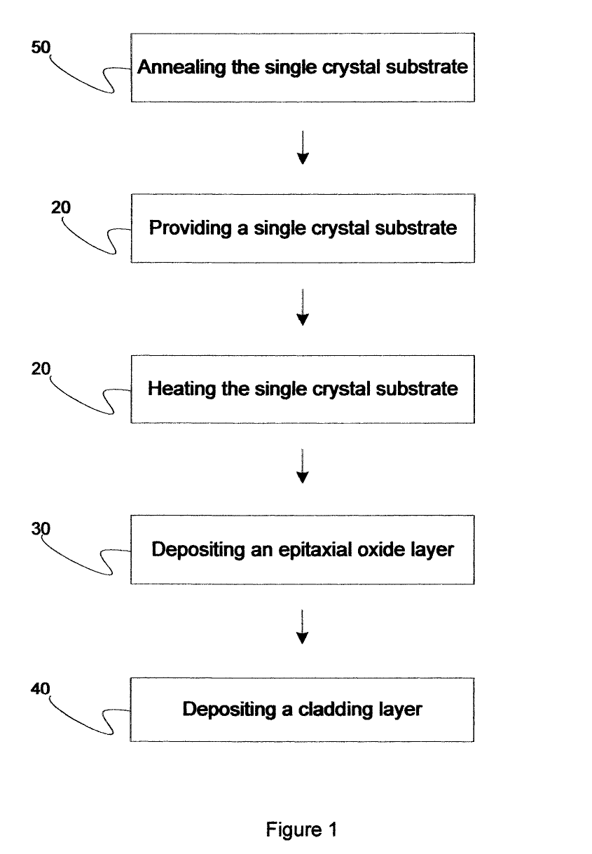

Thus, in one embodiment and with reference to FIG. 1, the inventive method for making an optical waveguide structure comprises the following steps: (1) providing a single crystal substrate 10; (2) heating the single crystal substrate 20; (3) depositing an epitaxial oxide layer (i.e., core layer) on the single crystal substrate 30; and (4) depositing a cladding layer on the epitaxial oxide layer 40. In addition, the inventive method may also include an initial step of annealing the single crystal substrate so as to form a plurality of atomically flat terraces 50.

More specifically, the inventive method for making an optical waveguide structure involves the use of MBE and includes following steps: First, an appropriately cleaned single crystal substrate is placed in a growth chamber and an ultra-high vacuum (UHV) environment is achieved. The single crystal substrate may be composed of, for example, sapphire or yttrium aluminum garnet (YAG). If sapphire is used, then it may be either C-, M-, R-, or A-plane sapphire; however, the best results have thus been obtained when R-plane sapphire has been selected. The thickness of the single crystal substrate should generally range from about 0.05 mm to about 2 mm. In addition, and prior to placement within the growth chamber, the single crystal substrate should be air-annealed in a furnace at a temperature of at least 900° C., and preferably a temperature ranging from about 1,000° C. to about 1,300° C., and even more preferably at a temperature of about 1,100° C., and for a sufficient period of to form a plurality of atomically flat terraces on the substrate. We have found that annealing at 1150° C. in air for 9 hours works well, although the exact length of time is not critical. The annealing step aids the formation of a plurality of atomically flat terraces. The single crystal substrate should also metallized on the back (i.e., non-growth) surface with, for example, chromium and then molybdenum to facilitate effective radiative heating during subsequent material growth. Finally, and also prior to placement within the growth chamber, the single crystal substrate should be cleaned with, for example, hot acetone and methanol.

Next, a rare-earth doped core layer such as, for example, neodymium-doped yttrium oxide (i.e., Nd:Y₂O₃) is grown by evaporating neodymium and yttrium simultaneously under an over pressure of oxygen gas. In a preferred embodiment Y₂O₃ is grown in the form of an epitaxial layer or film on a single crystal sapphire substrate at about 1,100° C. In this embodiment, the yttrium metal is evaporated in the presence of a molecular oxygen beam with a beam equivalent pressure of about 10⁻⁶ to about 10⁻⁵ mBar, while the neodymium metal is evaporated as a metal powder from a pyrolytic boron nitride crucible. Epitaxial means that the crystal structure of the deposited Y₂O₃ layer is aligned with the crystal structure of the sapphire substrate in approximately the same relative orientation for substantially the entire film. The alignment of the crystal structure of the layer may be determined by high resolution x-ray diffraction, as is well-known in the art, by measuring the location and shape of various Bragg diffraction peaks. In some cases, the epitaxial film may be separated into two or more domains that have different alignment in the plane of the substrate but the same crystal orientation perpendicular to the plane of the substrate.

The degree of order or perfection in the crystalline structure of the epitaxial film may be determined from the sharpness of the Bragg peaks. A high quality epitaxial film will have sharp Bragg diffraction peaks. A Bragg peak that is approximately one degree in width or less in a θ/2θ scan is considered to be sharp. The growth of high quality epitaxial films on a sapphire substrate is favoured by annealing the substrate in air at about 1,100° C. In a preferred embodiment, the substrate may be annealed for about 9 hours at about 1,150° C., but the length of time is not considered to be critical. The purpose of the annealing process is to grow the size of the atomically flat terraces on the surface of the substrate. In a single crystal sapphire substrate whose surface is aligned nearly parallel to a low index crystal plane, the surface will show atomically flat terraces separated by atomic steps. For typical annealing conditions the atomically flat terraces will be about 100 nm wide or wider. The exact width of the terraces is not critical, except that the wider the terraces the higher the degree of perfection that can be expected in the structure of the epitaxial layer. Epitaxial films with high degrees of structural perfection show superior optical properties. Optical properties of interest include low scattering and absorption losses and sharp rare earth emission lines.

Low optical scattering losses are favoured by high degrees of crystalline order and by low surface roughness. Low absorption losses are favoured by low densities of point defects such as oxygen vacancies. In the case of the aluminum oxide cladding layer, the surface roughness and density of point defects are found to be lower if the aluminum oxide is grown with a mixture of oxygen and hydrogen than if the film is grown with oxygen only. In this case, the hydrogen is believed to act as a surfactant. A surfactant is an element that attaches to the surface and modifies the surface chemistry that takes place during growth, but does not incorporate into the layer. A hydrogen surfactant can also be used in the growth of the epitaxial oxide layer. In a preferred embodiment for the growth of the aluminum oxide cladding layer the hydrogen and oxygen gas are introduced into the plasma source simultaneously and the plasma discharge contains both hydrogen and oxygen gas. The hydrogen may also increase the reactivity of the oxygen produced by the plasma source which is advantageous in that it favours the growth of layers with low densities of oxygen vacancies. Ozone and atomic oxygen are well known to have high reactivity compared with molecular oxygen. In a preferred embodiment the interface roughness between the cladding layer and the epitaxial oxide layer is less than about 20 nm rms.

The aluminum oxide (Al₂O₃) cladding layer may be deposited at a rate of about 0.2 microns/hr in the presence of a background chamber pressure of about 0.5×10⁻⁶ to about 8×10⁻⁶ mBar of oxygen that is introduced into the MBE growth chamber through a RF plasma source which increases the chemical reactivity of the oxygen. The presence of hydrogen reduces the surface roughness of the Al₂O₃. The A1₂O₃ may also be deposited by electron beam evaporation in a background oxygen pressure of about 5×10⁻⁶ mBar on a substrate held at about 200° C. In this alternative embodiment and for best film quality, the structure is annealed in air at 1,100° C. for about 1 to 5 hours after growth.

It is believed that our growth method can be applied to any of the 13 rare-earth elements or combinations of these elements. The waveguide structures can be designed to emit in the mid-infrared (3 micron wavelength) that is inaccessible to semiconductor devices or in the visible using upconversion of frequency doubling.

For purposes of illustration and not limitation, the following example more specifically disclose exemplary manufacturing steps and actual experimental results associated with a planar optical waveguide structure made in accordance with the present invention.

### EXAMPLE

Neodymium doped yttrium oxide thin films were grown on Si (001) and sapphire (0001) substrates by Molecular Beam Epitaxy (MBE) using thermal evaporation of yttrium and neodymium metal. Our growth conditions exhibit single-crystallinity, low mosaicity and strong photoluminescence of neodymium transitions at room temperature. The optimal neodymium dopant concentration for luminescence was determined.

We grew Y₂O₃ on Si (100) and sapphire (0001) substrates. Using sapphire as a substrate is useful for planar waveguide lasers (PWLs) due to its lower refractive index (n_{Al2O3}≈1.77 and n_{Y2O3}≈1.85 at 1 μm). In addition, our oxide MBE system is capable fabricating symmetric waveguides by growing a sapphire cladding layer after the growth of Nd:Y₂O₃.

To grow Y₂O₃, we used an yttrium metal effusion cell heated between 1600° C. and 1750° C. to obtain yttrium fluxes between about 5×10⁻³ and about 5×10⁻⁷ mBar, measured with an ion gauge placed in front of the substrate. Oxygen was introduced into the chamber through a leak valve. The oxygen partial pressure in the growth chamber during Y₂O₃ growth was chosen to be typically equal to ten times the yttrium flux. To dope the Y₂O₃ with neodymium, a neodymium cell heated to around 1000° C. was used to obtain a neodymium flux of a few percent of the yttrium flux. We studied the influence of the growth temperature, the oxygen pressure/yttrium flux ratio and yttrium/neodymium flux ratio on the structural and photoluminescence (PL) properties of the neodymium doped samples.

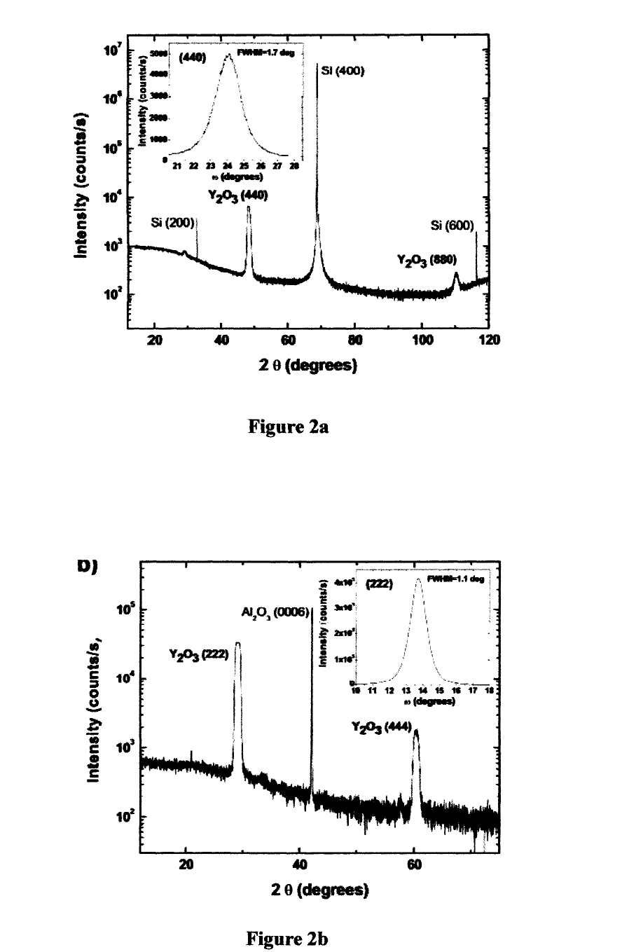

Although growth of yttrium oxide directly on a silicon substrate does not make an optical waveguide because the index of refraction of silicon is larger than yttrium oxide, it is useful for purposes of illustrating how the various aspects of the growth process affect the properties of the yttrium oxide epitaxial layer. Thus, and for the growth on silicon substrates, the substrates were HF deoxidized in a clean environment before being introduced into the growth chamber and heated at 900° C. to obtain a clean Si surface free of oxide. We started to grow about 1 nm of yttrium metal before the growth of Y₂O₃ to avoid the reoxidation of the HF cleaned substrate and the formation of a SiO₂ interfacial layer. To grow 1 nm of yttrium metal the surface was exposed to an yttrium flux of typically about 2×10⁻⁷ Torr for a few seconds. Then the yttrium cell was closed and a partial oxygen pressure typically of 2.5·10⁻⁷ Torr was introduced in the growth chamber. The Y₂O₃ growth was started by reopening the yttrium cell when the pressure into the growth chamber was stabilized. To obtain good structural quality, a ratio of 10 between the oxygen pressure and the yttrium flux was used. The growth temperature was controlled by thermocouple and checked by a pyrometer. In those conditions, single crystal orientation along the growth axis of Y₂O₃ was found for growth temperatures between 350° C. and 800° C. For a growth temperature of 350° C. the heteroepitaxial relation Y₂O₃ (111)∥Si (100) was found. For a growth temperature of 650° C. the Y₂O₃ (001)∥Si (001) is the main growth direction of Y₂O₃. FIG. 2a) presents the XRD pattern of a Y₂O₃ sample grown at 900° C. It presents the Y₂O₃ (110)∥Si (100) heteroepitaxial relation: the two strong peaks correspond to Y₂O₃ (440) and Y₂O₃ (880). This growth temperature gives the best structural quality in terms of the width of the Y₂O₃ peaks in rocking curve measurements. This width decreases with increasing the Y₂O₃ layer thickness. In the inset of FIG. 2a), we show the rocking curve on the (440) peak of a 60 nm thick Y₂O₃ sample grown at 800° C. The width of 1.7 degrees is one of the best values reported in the literature. For a growth temperature of 1000° C. the XRD pattern does not present any Y₂O₃ peaks but only YSi₂ peaks. Those peaks were also observed at lower temperature, when an oxygen pressure/yttrium flux ratio smaller than 10 was used at growth temperatures between 350° C. and 800° C. In our case, the growth of a thin yttrium metal layer before the Y₂O₃ growth seems to avoid the formation of YSi₂ up to a growth temperature of 800° C. In our growth procedure, we expose the surface to oxygen before starting the growth of Y₂O₃. During this step, the yttrium silicide is probably oxidized into Y₂O₃.

FIG. 2b) presents the θ-2 θ XRD pattern of a Y₂O₃ sample grown on sapphire (0001) at 1100° C. We investigated growth temperatures between 450° C. and 1100° C. for growths on sapphire. The heteroepitaxy relation found was always Y₂O₃ (111)∥Al₂O₃ (0001). The smallest width of Y₂O₃ peaks in rocking curve measurements was found for growth temperatures of 1100° C. Rocking curves on the (222) peak of Y₂O₃ exhibit widths as small as 1.1 degrees (cf the inset of FIG. 2b)).

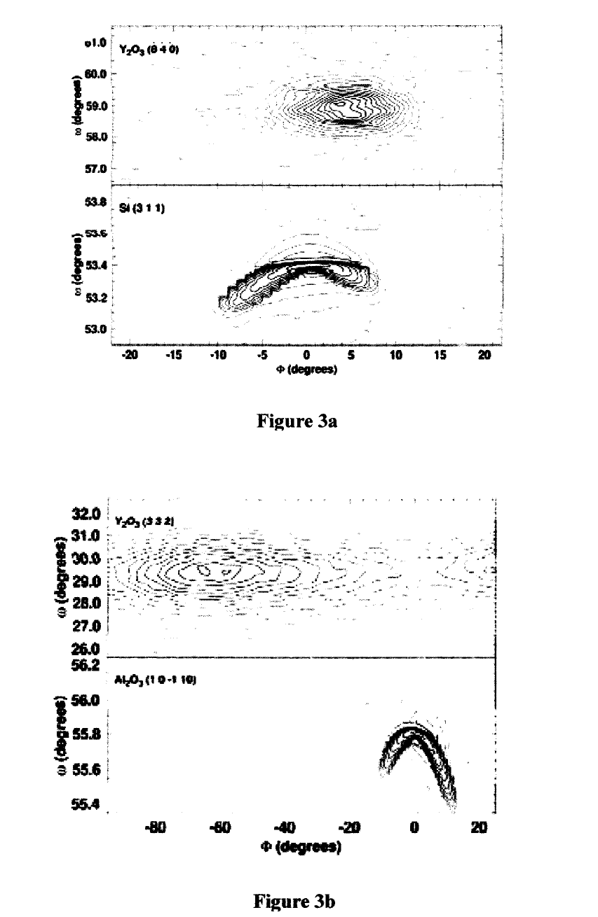

To measure the in-plane orientation, we measured texture maps around off-axis peaks of the Y₂O₃ and of the substrate for sample grown on Si (100) and on sapphire (0001) doing a series of Φ scans for different ω positions (cf. FIG. 3). The shapes of the substrate peaks are due to instrumental broadening due to beam divergence. The Φ scans on the Y₂O₃ off-axis peaks present a 3-fold symmetry. On FIG. 3a) we see an offset of 4 degrees on the Φ axis between the (840) peak of Y₂O₃ and the (311) peak of silicon. Calculating the projections of the (840) peak on the (110) plane for Y₂O₃ and of the (311) peak on the (100) plane for silicon we determined that the [1 −1 0] in-plane direction of Y₂O₃ is rotated by 4 degrees from the (011) direction of silicon. Actually, Φ scans on a 360 degrees range showed that two types of domains rotated 90 degrees through an axis perpendicular to the surface exist for Y₂O₃ films grown on Si (100) at 800° C. As said before, the first domain in-plane orientation is [1 −1 0] Y₂O₃∥[011] Si within 4 degrees. The second domain in-plane orientation is [0 0 1] Y₂O₃∥[011] Si within 4 degrees. On FIG. 3b) we see an offset of 60 degrees on the Φ axis between the (332) peak of Y₂O₃ and the (1 0 −1 10) peak of sapphire. Calculating the projections of the (332) peak on the (111) plane for Y₂O₃ and of the [1 0 −1 10] peak on the (0001) plane for sapphire we determined that the [1 1 −2] in-plane direction of Y₂O₃ is rotated by 60 degrees from the [1 0 −1 0] direction of sapphire.

Strong PL at room temperature was measured for neodymium doped samples grown on Si (100) and on sapphire (0001). A large oxygen/yttrium flux ratio (of about 10) is a precondition for strong luminescence.

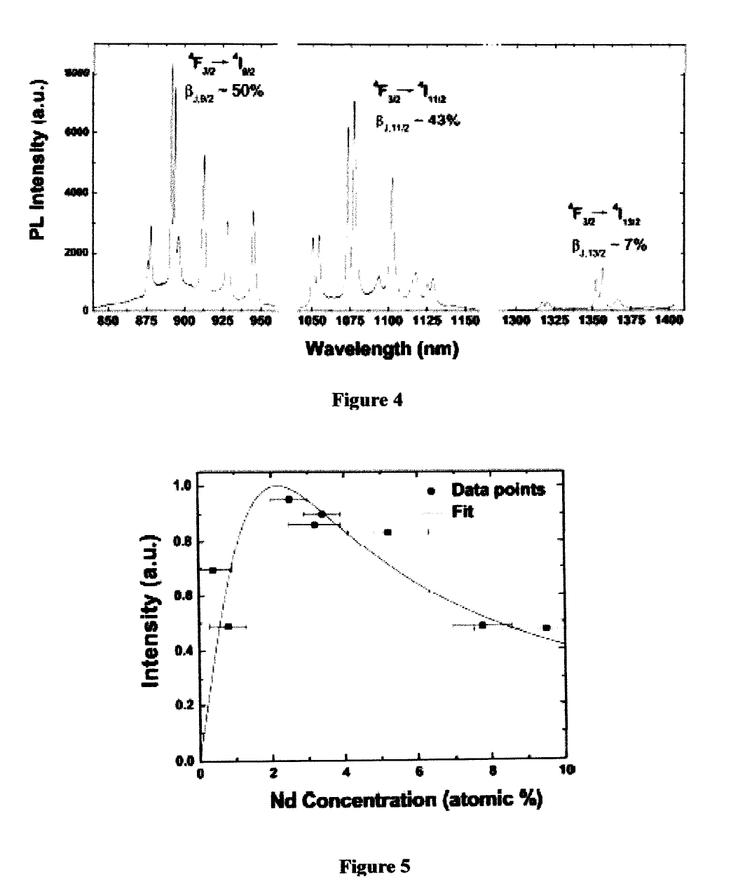

FIG. 4 shows the PL spectra of three spectral regions of a 2.2 μm thick 1.35% Nd:Y₂O₃ sample grown on sapphire (0001) with an oxygen pressure/yttrium flux ratio of 10. The PL excitation source is a semiconductor laser diode at 808 nm. The excitation density is about 2 W/cm². Emission is analyzed by a 15 cm focal length monochromator with 600 lines/mm grating. The three spectral regions correspond to the ⁴F_{3/2}→⁴I_{9/2}, ⁴F_{3/2}→⁴I_{11/2} and ⁴F_{3/2}→⁴I_{13/2} channels of Neodymium. The position of the emission lines are very similar to the ones reported in literature for Nd:Y₂O₃ ceramic samples. We calculated the branching ratio of each deexcitation channel. The strongest transitions corresponds to the ⁴F_{3/2}→⁴I_{9/2} channel.

For samples grown on silicon with an oxygen pressure/yttrium flux ratio of 10, the neodymium emission lines are superimposed with the band edge emission of silicon. This shows that Y₂O₃ grown in these conditions is transparent. For samples grown with an oxygen pressure/yttrium flux ratio smaller than 10, the band edge emission of silicon is not visible and the PL intensity of the neodymium lines is much weaker. This shows that in this case the Y₂O₃ films are not transparent which could be due to the existence of a YSi₂ layer (YSi₂ lines are observed in the XRD spectrum when the oxygen pressure/yttrium flux ratio is smaller than 10).

In FIG. 5, we show the PL intensity of the ⁴F_{3/2}→⁴I_{11/2} transitions vs. Nd concentration. For this study, we grew eight 430 nm thick samples of Nd:Y₂O₃ on sapphire using similar growth conditions with the exception of a varying Nd/Y flux ratio. The Nd concentration was deduced from this flux ratio assuming complete Nd incorporation. From our results, we observe fluorescence quenching: for low Nd concentrations the PL intensity increases with concentration to a peak value around 2%, but decreases with further increases in concentration. This quenching effect is due to cross relaxation interactions between Nd ions. Assuming an N² dependence on the non-radiative relaxation rate, we can now express the fluorescence efficiency as 1/(1+AN₂) where N is the Nd concentration. Factoring in absorption, the total PL emission can be fitted to the form BN/(1+AN₂), where A and B are fitting parameters. Using this model, we found an optimal dopant concentration of 2.1%.

To conclude, Nd doped Y₂O₃ has been grown via MBE on Si (001) and Al₂O₃ (0001) substrates. The growth conditions were optimized to have good crystallinity and photoluminescence. The optimal Nd concentration was determined. Those results should allow us to fabricate planar waveguide lasers.

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. It will be apparent to those skilled in the art that various modifications and variations can be made without departing from the spirit or scope of the invention as it is described in the appended claims. Finally, all of the various references cited herein are incorporated by reference in their entireties for all purposes.

What is claimed is:

1 A method for making an optical waveguide structure, comprising:
providing a single crystal substrate in an ultra-high vacuum (UHV) environment, wherein the single crystal substrate has a first index of refraction;
heating the single crystal substrate to a temperature of at least 600° C.;
depositing an epitaxial oxide layer of uniform thickness and having a second index of refraction on the single crystal substrate, wherein the epitaxial oxide layer includes at least one optically active rare-earth dopant, and wherein the epitaxial oxide layer is deposited by way of at least first, second, and third molecular beam fluxes, wherein the first molecular beam flux is a metallic molecular beam flux, the second molecular beam flux is a rare-earth element molecular beam flux, and the third molecular beam flux is a gaseous or plasma molecular beam flux; and
depositing a cladding layer on the epitaxial oxide layer, wherein the cladding layer has a third index of refraction that is the same or about the same as the first index of refraction of the single crystal substrate, and wherein the second index of refraction is greater than the first and third indexes of refraction.

2. The method of claim 1, further comprising an initial step of annealing the single crystal substrate to a temperature of at least 900° C. and for a period of time sufficient to form a plurality of atomically flat terraces on the single crystal substrate.

3. The method of claim 1 wherein the single crystal substrate is composed of sapphire or yttrium aluminum garnet (YAG).

4. The method of claim 3 wherein the sapphire is R-plane sapphire.

5. The method of claim 3 wherein the single crystal substrate has a thickness that ranges from about 0.05 mm to about 2 mm.

6. The method of claim 1 wherein the first and third indexes of refraction range from about 1.3 to about 1.7.

7. The method of claim 1 wherein the step of depositing the epitaxial oxide layer occurs at a temperature that ranges from about 900° C. to about 1,300° C.

8. The method of claim 1 wherein the epitaxial oxide layer is composed of a core material selected from yttrium oxide, yttrium aluminum garnet (YAG), yttrium gallium garnet (YGG), yttrium vanadate, or yttrium aluminum perovskite having a rare-earth dopant.

9. The method of claim 1 wherein the epitaxial oxide layer is composed of yttrium oxide having a neodymium dopant.

10. The method of claim 8 wherein the epitaxial oxide layer has thickness that ranges from about 500 nm to about 5,000 nm.

11. The method of claim 8 wherein the rare-earth dopant has a uniform or a non-uniform concentration gradient across the epitaxial oxide layer.

12. The method of claim 1 wherein the second index of refraction ranges from about 1.8 to about 1.9.

13. The method of claim 1 wherein the at least one optically active rare-earth dopant is selected from cerium, neodymium, gadolinium, erbium, praseodymium, holmium, or ytterbium.

14. The method of claim 1 wherein the metallic molecular beam flux is selected from a yttrium, gallium, aluminum, or vanadium molecular beam flux.

15. The method of claim 1 wherein the metallic molecular beam flux is a yttrium molecular beam flux.

16. The method of claim 1 wherein the metallic and rare-earth molecular beam fluxes are produced by thermal effusion cells.

17. The method of claim 1 wherein the metallic molecular beam flux is produced by an electron beam gun.

18. The method of claim 1 wherein the rare-earth element molecular beam flux is selected from a cerium, praseodymium, neodymium, gadolinium, holmium, erbium, or ytterbium molecular beam flux.

19. The method of claim 1 wherein the rare-earth element molecular beam flux is a neodymium molecular beam flux.

20. The method of claim 1 wherein the gaseous or plasma molecular beam flux is selected from an oxygen, ozone, hydrogen, water vapor, or combination thereof gaseous or plasma molecular beam flux.

21. The method of claim 1 wherein the cladding layer is composed of a cladding material selected from aluminum oxide silicon dioxide, or spin-on glass.

22. The method of claim 20 wherein the cladding layer is composed of aluminum oxide.

23. The method of claim 20 wherein the cladding layer has a thickness that ranges from about 500 nm to about 10,000 nm.

24. The method of claim 1, further comprising a step of metallizing the single crystal substrate with a layer of at least one metal on the face that is opposite the single crystal oxide layer.

25. The method of claim of claim 24 wherein the at least one metal is selected from chromium, molybdenum, or a combination thereof.

26. The method of claim 1 wherein the ultra-high vacuum (UHV) environment occurs within a growth chamber, and wherein the gaseous or plasma molecular beam flux creates a pressure in the growth chamber of less than 10⁻⁴ mbar.

27. An optical waveguide structure made in accordance with the method of claim 1.
